(19) United States
(12) Patent Application Publication
(10) Pub. No.: US 2018/0093519 A1
(43) Pub. Date: Apr. 5, 2018

(54) LIQUID CRYSTAL COLOR-SHIFTING SECURITY DEVICE

(71) Applicant: Crane & Co., Inc., Boston, MA (US)

(72) Inventors: Pearl N. Dickerson, New Boston, NH (US); Nancy J. Gettens, Waban, MA (US); David L. Peters, Amherst, NH (US)

(73) Assignee: Crane & Co., Inc., Boston, MA (US)

(21) Appl. No.: 15/720,487

(22) Filed: Sep. 29, 2017

Related U.S. Application Data
(60) Provisional application No. 62/402,503, filed on Sep. 30, 2016.

(51) Int. Cl. B42D 25/364; G02B 5/20; B42D 25/29; B42D 25/373; B42D 25/355; B32B 15/04

(52) U.S. Cl. CPC B42D 25/364; G02B 5/20; B42D 25/29; G02B 1/02; B42D 25/355; B32B 15/04; B42D 25/373

(57) ABSTRACT

Presented herein are layered systems, security devices formed from the layered systems and methods of manufacturing those layered systems and security devices. The security devices provide several effects including, but not limited to, (1) color-shifting effects that are observable as the points of view of the observant changes and (2) customizable micro-text formed in the security device by demetallization of a metallic layer provided on or within the security device. The method of manufacturing the security devices includes manufacturing a layered system that is used to form the security devices. As will be described in further detail herein, the method of manufacturing the layered system includes providing a substrate layer having a metallic layer, masking at least parts of that metallic layer with an opaque material to form masked metal areas and exposed metal areas, removing metal from the exposed metal areas to form de-met areas, covering the masked areas and the de-met areas with a liquid crystal material. The layered system that results from the method which includes these steps provides a color-shifting effect from the liquid crystal material and a micro-text effect from the contrast between the de-met areas and the masked metal areas. Security devices formed from the layered system can take various shapes, sizes and colors. Such security devices suitable for various applications including, but not limited to, uses for authenticating consumer products, security documents, identification documents, and various other high value or high security products. Alternatively, such security devices are also suitable for providing aesthetic properties. The resulting security devices comprise the layered system which comprises a substrate layer with a metallic layer having masked metal areas and de-met areas, and a liquid crystal layer.

### RELATED APPLICATION

This application claims priority to U.S. Provisional Patent Application Ser. No. 62/402,503, filed Sep. 30, 2016, which is incorporated herein in its entirety by reference.

### TECHNICAL FIELD

Layered systems are often used to produce security devices where the devices provide optical effects that are very difficult to replicate. In industries that involve the sale and/or manufacture of high value or high security products, such as currency documents, identification documents, expensive personal apparel, national security products, and the like, it is critical that consumers and users of such products have confidence that the products they are using are authentic. With the recent advent of certain high resolution printers and other replication technologies such as 3-D printing, it has become even more critical that such high value or high security products are readily and easily susceptible to authentication by consumers. Applicant has developed certain devices that are aimed at thwarting the efforts of those who would seek to counterfeit those high value or high security products. These devices are formed from a layered system that produces color-shifting effects and micro-text effects that are readily observable yet are very difficult to replicate even in view the current technological advancements highlighted above.

### BACKGROUND

Due in part to the technological advances made in the printer industry and other replication and duplication technologies, proprietors of high value products or high security products have consistently demanded security devices and features that can be used to distinguish their authentic products from products of counterfeiters. Often times, it is also required that these security devices provide aesthetic features.

For example, the efficiency and improved quality of modern photocopiers have coincided with increases in counterfeited security documents such as identification cards, banknotes, checks, stamps and the like. Several attempts have already been made to prevent such documents from being counterfeited. These include, for example, various devices that provide visual mobile changes as those devices are viewed from varying angles or points of view. Such mobile features cannot be reproduced by even the most advanced printers. Other examples include affixing security features to such documents that provide a visual effect that is observable in transmitted light but is not observable in reflective light. Such security features rely on some of the deficiencies that still remain with sophisticated printers. Namely, because photocopiers rely on reflective light, this prevents the use of photocopiers to produce the security features that are only observable in transmitted light.

Machine readable security features are disclosed in EP 0310707 where a security device is provided with a magnetic coating which serves as a machine readable security feature. EP 0407550 further provides that the magnetic coating may intermittently be applied to a substrate such that a binary code, consisting of the magnetic material, can be read. For example, the coating of a bit length of magnetic material will correspond to and register a 1 while a bit length without any magnetic material will register a 0. While such security devices provide some counterfeiting deterrence, significant disadvantages still plaque such security devices. For example, there is no ability for the general consumer of products marked by such security devices to easily and quickly visually confirm the authenticity of the product by observing the security device.

Metallized films are also previously described in U.S. Pat. No. 4,652,015. These films are produced by presenting metal in controlled and clearly defined areas and/or metal is demetalized in other clearly defined areas. One way of manufacturing such demetalized films is to selectively demetalize areas using a resist to mask areas not intended for demetallization and etching the exposed metal areas. It is also possible to vacuum deposit aluminum through a mask or it can be removed in defined areas from a laminated strip of a plastic base and aluminum coat. These processes can be used to create various micro-text features in the security device. Unfortunately, while such micro-text features are difficult to produce, they are easier to mimic since they remain static.

The use of liquid crystal materials to provide variable color effects is also described in U.S. Pat. No. 5,678,863 where it is disclosed that liquid crystal material can be applied to a translucent or transparent paper or polymer to overlap with a watermark feature. In such instance, the variation in color is observed when the watermark feature is observed in reflective light versus when it is observed in transmitted light. While there are certain advantages to such applications, various disadvantages make this feature less than desirable for high value or high security products. For example, such applications are complicated and require registration of the liquid crystal material with the tonality of the watermark to achieve the desired color shift from reflective light to transmitted light in desired areas. Furthermore, the tonality of the watermark is also negatively impacted by the liquid crystal material rather than providing a synergistic effect between the liquid crystal material and the watermark feature.

The use of liquid crystal materials to provide variable color effects is also described in U.S. Pat. No. 7,179,393. Here a security device is disclosed which comprises a polymeric liquid crystal material that is applied to a second side of a darkly-colored resist layer. This resist layer is affixed, on its first side, to a metallic layer that is in turn affixed on an opposing side to a base substrate. The resist layer covers only parts of the metallic layer so that some areas of the metallic layer remain uncovered by resist. The areas covered by the polymeric liquid crystal material and the darkly-colored resist produces variable color effects as the security device is viewed from varying points of view in reflected light. Moreover, the metallic areas not covered by the resist contrast with the areas covered by the resist to produce an observable micro-text effect. Here significant disadvantages are attributable to the construction of such a device. For example, the use of a polymeric liquid crystal material is accompanied by lack of process controls and high manufacturing costs. For example, manufacture of a layered system with polymeric liquid crystal material would require multiple process layering steps in order to incorporate the liquid crystal material into a layered system. Often it is required that the liquid crystal material is added to a carrier film before it is placed over a demetalized laminate of base substrate, metal and resist. By such a two-step process it is difficult to control, real time, the desired color-shift. Similarly, disposing a darkly-colored resist in contact with the metallic layer also presents its own challenges and disadvantages. Often it is required to perform durability testing of layered systems. This is often performed in highly basic or highly acidic environments. Under such caustic environments, the highly basic or highly acidic formulations result in corrosion of any metal disposed under and next to the dark resist. Applicant has found that the pigment found in most darkly-colored resist materials leaves the metal layer susceptible to corrosion because the pigment reduces the adhesion of the darkly-colored resist film to the metal layer. This in turn results in lateral diffusion of the caustic materials that are used either for demetallizing the layered system or for durability testing.

Accordingly, there remains a need for other security devices that can prevent counterfeiting attempts. More particularly, there remains a need for a security device that can provide optical variability such that high value and high security products can be readily and easily authenticated by the consumers. Furthermore, there remains a need for security devices that do not suffer from the deficiencies of conventional devices as described above.

### SUMMARY

Applicant, through careful experimentation and thorough development have discovered that a security device or aesthetic device (collectively referred to as security device) can readily and easily provide verification that a product is authentic by providing a layered system having a color-shifting effect and/or a micro-text effect. More particularly, Applicant has discovered that a layered system having a primer layer disposed between an opaque layer and a metallic layer can avoid the disadvantages of certain conventional security devices. By disposing the primer layer between the opaque layer and the metallic layer, the opaque layer is disposed at a distance from the metallic layer, resulting in reduced corrosion to the metal layer during durability testing and reduced lateral diffusion of any caustic material used during demetallization or durability testing. This discovery is coupled with the further discovery that a primer layer, having little to no pigment, allows for improved adhesion of the primer layer to the metal layer, thereby protecting the metal layer to provide cleaner lines with higher resolution when the metal layer is demetalized. Moreover, Applicant has discovered that certain disadvantages of conventional liquid crystal security devices can be eliminated by applying a monomeric liquid crystal material and curing the monomeric liquid crystal material in situ to provide a polymeric liquid crystal material. Particularly, it has been found that by applying a monomeric liquid crystal material over the de-met areas and the masked metal areas allows for improved process control. Particularly, Applicant has found that it becomes much more cost effective where the product specifications/results (i.e., color-shift effect) can be controlled or manipulated in real-time during the same forming process used to produce the layered system containing the liquid crystal layer, the resist, the de-metallized paper and the base substrate. As such one would be able to see the color-shift effect and set that effect as desired, during the manufacturing of the layered system. This reduces cost and improves process control and development.

In a first aspect, a method of producing a layered system is provided and disclosed herein. In one embodiment, the method of producing a layered system comprises providing a base substrate having a metallic layer disposed over a first side of the base substrate; covering at least a part of the metallic layer with a primer layer; covering at least a part of the primer layer and masking at least a part of the metallic layer with an opaque layer to form masked metal areas and exposed metal areas; demetallizing the exposed metal areas to form de-met areas in the metallic layer; and applying a liquid crystal material to cover the masked metal areas and the de-met areas. The metallic layer being disposed over the base substrate includes embodiments where the metallic layer is either directly applied to the base substrate or is situated at a distance away from the base substrate. The opaque layer is never applied to the metallic layer. Stated another way, the opaque layer is never touching the metallic layer, but is instead disposed at a distance away from the metallic layer.

In a second aspect, a layered system is provided and disclosed herein. In one embodiment, the layered system comprises a base substrate having a metallic layer with masked areas and de-met areas where the metallic layer is disposed on a first side of the base substrate; a patterned primer layer disposed over the metallic layer; a patterned opaque layer disposed over the primer layer such that at least a part of the metallic layer is masked by the opaque layer; and a layer of liquid crystal material disposed over the patterned opaque layer to cover the masked areas and the exposed areas. The metallic layer has masked areas and de-met areas. The opaque layer is never applied to the metallic layer.

In a third aspect, a security device is provided and disclosed herein. In one embodiment, the security device comprises a layered system as described above. In a fourth aspect, a high value or high security product (i.e., documents such as banknotes, passports and identification cards, or expensive personal products, international or national security equipment or products) is provided. In one embodiment, the high value or high security product comprises a security device or layered system as described above and formed in desired shapes, sizes or colors. In a fifth, product-by-process aspect, a layered system manufactured by the method described above is provided and disclosed herein. In one embodiment, the layered system manufactured by the method described herein comprises a base substrate having a metallic layer with masked areas and de-met areas where the metallic layer is disposed on a first side of the base substrate; a patterned primer layer disposed over the metallic layer; a patterned opaque layer disposed over the primer layer such that at least a part of the metallic layer is masked by the opaque layer; and a layer of liquid crystal material disposed over the patterned opaque layer to cover the masked areas and the exposed areas. The metallic layer has masked areas and de-met areas.

The invention will be described in further details below by reference to several embodiments of the claimed invention. While such embodiments and their details are provided such that a person having ordinary skill in the art (PHOSITA) may be able to understand and practice the claimed invention, such embodiments are not intended to limit the scope of the claimed invention. Embodiments provided herein are therefore provided as non-limiting examples of the claimed invention. Further features of the claimed invention will therefore become apparent from the following description of exemplary embodiments.

### WRITTEN DESCRIPTION

### Definitions

As used herein, the term “covering” refers to the step of covering by placing a covering material between an observer's point of view and an object to be viewed. This may include setting the covering material at a distance from the object to be viewed or placing the covering material directly against the material to be viewed.

As used herein, the term “disposed” refers to the placement of a particular component at a desired or defined location, such as within a layered system or next to a layered system.

As used herein, the term “identical” refers to two or more components having the same dimensions and shall include substantially identical wherein the purpose of neither of the components are thwarted by any deviation from the exact same dimensions.

As used herein, the term “layer” refers to a component distributed continuously or discontinuous, or as specified, over or beneath, another component.

As used herein, the term “masking” refers to the process of covering or shading an area by disposing that area beneath a material that inhibits at least one of the view or detection of the covered area, when viewed or detected from a side proximate to the material used for masking.

As used herein, the term “nancy layer” refers to a layer of resist that is clear upon application over the metallic layer but is cured in situ to a darkly-colored resist.

As used herein, the term “over” as used regarding the relative location of the components of the layered system or device refers to the placement of the referenced component as being either in direct contact with the component it is situated over or is indirectly in contact (as in when another layer is disposed there-between).

As used herein, the term “pattern” refers to any form of positively formed or negatively formed indicia, including but not limited to, letters, numbers, symbols, etc. that are provided in the metallic layer, the primer layer, or the resist layer.

### BRIEF DESCRIPTION OF DRAWINGS

Understanding of the claimed invention may further be enabled by the drawings provided herein and by the following brief description of those drawings. Drawings provided herein may not be to scale and are only provided as point of reference embodiments and should not be construed as limiting the breadth of the claimed inventions unless so claimed.

FIG. 10a provides a cross-sectional view of a base substrate overlaid with a metallic layer.

FIG. 10b provides a cross-sectional view of a base substrate overlaid with a metallic layer and a primer ayer.

FIG. 10c provides a cross-sectional view of masked metal area of a layered system.

FIG. 10d provides cross-sectional view of a masked metal area of a layered system covered by a liquid crystal material.

FIG. 10e provides a cross-sectional view of a layered system having masked metal areas, de-met areas and a liquid crystal material.

FIG. 20 provides a view of a banknote having two security devices disposed on a surface of the banknote.

FIG. 30 provides a cross-sectional view of a layered system without a primer layer but including at least one of a monomeric liquid crystal material or a nancy layer.

### DETAILED DESCRIPTION

The present invention provides a security device that is capable of demonstrating optically variable effects. These optically variable effects include, for example, color-shifting effects, micro-text effects or combinations thereof. Through these effects, counterfeiting efforts can be effectively thwarted or mitigated because these effects change depending on the point of view of the observant. Such point of view dependent effects are difficult or impossible to replicate by even the most advanced replication technologies.

The present invention provides a layered system, method of manufacturing such a system, and security devices and high value or high security products that incorporate the security device or layered system. The layered system comprises a liquid crystal material and a metallic layer with de-met areas and masked metal areas. An observant viewing the layered system from one angle will observe a first color scheme that will change to a different color scheme as the observant changes her point of view. Moreover, the observant will observe a reflective color scheme when the layered system is viewed in reflective light that will change to a transmitted color scheme when viewed in transmitted light. The de-met areas and the masked metal areas will interact to provide a contrast allowing the observer to see micro-text effects. For example the micro-text effects may be observable in transmitted light but not observable or less observable in reflected light. All of these effects are observed while avoiding certain disadvantages of the conventional systems discussed above.

In a first aspect, a method of producing a layered system is provided. One embodiment comprises providing a base substrate having a metallic layer disposed on a first side of the base substrate; covering at least a part of the metallic layer with a primer layer; covering at least a part of the primer layer and masking at least a part of the metallic layer with an opaque layer to form masked metal areas and exposed metal areas; demetallizing the exposed metal areas to form de-met areas in the metallic layer; and applying a liquid crystal material to cover the masked metal areas and the de-met areas.

The base substrate may be in various forms. Suitable exemplary base substrates include films, paper, board, leather, cellulose sheets, textiles, plastics, glass, ceramics and metals. While various plastics are contemplated, polyester films are preferred. Accordingly, the base substrate may be selected from polyethylene terephthalate (PET), polyvinyl alcohol (PVA), polycarbonate (PC), or di- or tri-acetyl cellulose (TAC). PET films are widely available and may be obtained from manufactures such as SABIC.

Water-impermeable base substrates are particularly desirable and suitable for disposing a metal layer thereon. In one embodiment, the base substrate is covered with a metallic layer. The metallic layer may be applied to the base substrate through various methods. For example, the metallic layer may be transferred, laminated, or vacuum deposited. Suitable metallic materials include Al, Cu, Ni, Ag, Cr, Pt—Rh alloy, or Ni—Cr alloy. The metallic layer may be applied as a continuous layer over the base substrate where it is then subsequently modified to provide a pattern in the metallic layer. For example, the metallic layer may be applied by any of the above referenced various methods or the like, and then demetalized to provide a pattern of de-met areas in the metallic layer. The pattern may be in the form of various indicia including, but not limited to, letters, numbers, symbols and the like. The de-met areas may have zero (full de-met) metallic material or simply just less (partial de-met) metallic material than neighboring metallic areas.

Alternatively, it is also contemplated that the metallic layer may be discontinuously applied by first demetallizing it to provide the pattern of de-met areas and then applying it to the base substrate or that the metallic layer is demetalized at the same time that the metallic layer is being applied to the base substrate.

In a preferred embodiment, the metallic layer is continuously applied to the base substrate and is subsequently demetalized to provide the pattern of de-met areas in the metallic layer. For example, in one embodiment of the method, the base substrate is provided with a continuous metallic layer disposed over a first surface of the base substrate. As used herein in reference to the metallic layer, Applicant notes that the term “continuous” means that the desired pattern of de-met areas, such as text, symbols, numbers and the like, are not present in the metallic layer. Conversely, a “discontinuous” metallic layer would have the pattern of de-met areas and metallic area.

The metallic layer, whether continuous or discontinuous, is then covered as defined herein. Particularly, the metallic layer is covered by a primer layer. The primer layer itself may be applied in a continuous or discontinuous manner and may have the same, or different, pattern from the metallic layer. Preferably, the primer layer has an identical pattern to the metallic layer. If the metallic layer is discontinuously applied to the base substrate the primer layer has a pattern that substantially tracks the pattern of the metallic layer. However, it is also contemplated that the primer layer has a different pattern than the metallic layer or that it has a pattern that is identical to the metallic layer. For example, in one embodiment, the metallic layer is applied in a continuous manner to the base substrate and is then covered by a continuous or discontinuous primer layer; preferably a continuous primer layer. In any case, the metallic layer, whether continuous or discontinuously applied or demetalized in situ (i.e., after the metallic layer is applied to the base substrate), shall have its entire metallic surface, opposing the base substrate, covered by the primer layer. The primer layer may be disposed at a distance from the metallic layer or may be disposed such that it is in direct contact with the metallic layer.

While various materials may be employed as the primer layer, all such primer layer materials are clear. As used herein, the term clear means that the primer layer is not darkly-colored and may be transparent or translucent. Where the primer layer has pigment, it is sufficiently transparent/translucent such that it does not scatter light. Accordingly, the primer layer disposed over the metallic layer is not darkly-colored or pigmented in a dark color. Preferably, though without limitation, the primer layer is transparent or translucent, and has a transparency of greater than 80%. Preferably, the primer layer has a transparency that ranges from about 85% to about 95%. Notwithstanding the ranges mentioned in the previous and penultimate sentences, all sub ranges within the specifically recited ranges are also contemplated within the scope of this invention.

Suitable materials for the primer layer include, without limitation, nitrocellulose and polysiloxane. Applicant has surprisingly found that these preferred primer layer materials allows easy removal in the de-met areas without increasing the lateral diffusion that would cause corrosion in the masked-metal areas. Preferably, the primer layer comprises nitrocellulose. Applicant has found that by disposing a primer layer between the metallic layer and the resist layer, the de-met areas are provided with higher resolution (i.e., sharper lines). Accordingly, the micro-text effect is improved over conventional approaches that employed a darkly-colored resist applied to the metal layer. Without wishing to be bound by any specific theory, it is believed that this improvement is due in part to the absence/reduction of pigmentation in the primer layer, thereby increasing the adhesion and masking of the masked metal areas.

In one embodiment of the method, the method comprises, inter alio, covering at least a part of the primer layer and masking at least a part of the metallic layer with an opaque layer to form masked metal areas and exposed metal areas. While various materials are contemplated for use as the opaque layer, in a preferred embodiment, the opaque layer is a layer of resist. While it is contemplated that the resist layer could be any material that can interact with the liquid crystal material to produce a color-shift effect while at the same time be suitable for masking areas in the metallic layer for demetallizing the metallic layer. Materials having a transparency of less than 80% are most suitable and a therefore preferred. Nonetheless all sub-ranges within the less than 80% range are also contemplated, including but not limited to 0% to 50% transparency as most preferred. In one embodiment, the opaque layer is a pigmented darkly-colored material, which includes, for example, a dark or black dye or pigment. For example, suitable dyes include Orasol Black X51available from Ribelin. Carbon Black 7 can be mixed into a binder material or carrier material having good adhesion to metal and possessing resistance to caustic washing. Depending on the desired level of darkness, the dye content can range from 0 wt % - 70 wt % of the coat of resist. Vinyl chlorides/cinyl acetate copolymers such as Union Carbide Ucar resins, Sun VHL 31534, or Waker Vinnol E 15/45 m are suitable resists.

The resist layer may be applied by printing, laminating, transferring or coating mechanisms available to those of ordinary skill in the art. While it is contemplated that the resist may be continuously applied to cover the entire surface (opposing the base substrate) of the primer layer, it is preferred that the resist layer be disposed over the primer layer such that it is either identical to the primer layer, having the same pattern or lack of pattern, or that it covers less than the surface area of the primer layer. In any case, the resist layer is disposed over the primer layer such that the resist layer is never in contact with the metallic layer.

In a preferred embodiment, the resist layer is disposed over the primer layer, and therefore also over the metallic layer. However, due to the presence of the primer layer, the resist layer is not in contact with the metallic layer. Accordingly, the resist layer is disposed at a distance away from the metallic layer thereby covering the primer layer and masking the metallic layer. Applicant has found that by disposing the resist layer at a distance away from the metallic layer such that the resist is not in contact with the metallic layer, this improves micro-text resolution while preventing metal layer corrosion during demetallization or durability testing in caustic environments.

In one embodiment, the method comprises providing a base substrate having a metallic layer disposed on a first side of the base substrate; covering at least a part of the metallic layer with a primer layer; covering at least a part of the primer layer and masking at least a part of the metallic layer with an opaque layer having clear windows to form masked metal areas, having dark areas and clear windows and exposed metal areas; demetallizing the exposed metal areas to form de-met areas in the metallic layer; and applying a liquid crystal material to cover the masked metal areas (including the dark areas and the clear windows) and the de-met areas.

As described herein, the term “clear” implies transparency or translucency. Accordingly clear windows in the opaque layer is a resist layer as described herein, but further comprising clear windows, such that an observant can see the metallic layer and/or the primer layer through the clear window of the resist.

Such clear windows allows for the utilization of the metallic layer or the primer layer to provide additional features. For example, in one embodiment, the primer layer comprises printed indicia viewable through the resist windows. In a further embodiment, the metallic layer, viewable through the resist window, provides a diffraction grating in the form of a holographic feature, thereby providing further color-shifting effects.

Covering the primer layer with the resist layer, as described, also causes a masking of the metallic layer by the resist layer. The resist being darkly colored functions in part to hide the metallic layer. The resist layer, like the primer layer, may be printed over the primer layer and metallic layer to produce a pattern, that may be identical to the metallic layer and/or the primer layer. Preferably, the metallic layer is continuously applied to the base substrate, the primer layer is discontinuously applied (i.e., in a pattern) to cover the metallic layer and the resist layer, having a pattern identical to the primer layer, is also discontinuously applied to cover the metallic layer and the primer layer. More preferably, the metallic layer is continuously applied directly to a first side of the base substrate; the primer layer, having a pattern such that it is discontinuously applied directly to a first side of the metallic layer, opposite the base substrate; the resist layer, having a pattern identical to the pattern of the primer layer such that it is discontinuously applied directly to a first side of the primer layer, opposite the base substrate and the metallic layer. This provides a metallized and printed substrate.

In one embodiment of the method, the method comprises, inter alio, demetallizing the metallic layer, as provided in the various embodiments described herein, to form de-met areas and masked metal areas in the metallic layer. The patterned resist layer provides exposed metal areas and masked metal areas. Masked metal areas are those metal areas disposed beneath areas where resist is present, while exposed metal areas are metal areas beneath the resist layer, where no resist is present. The patterned resist and the patterned primer layer therefore provide a pattern of exposed metal areas that are complementary to the pattern of resist material present in the resist layer and/or the pattern of primer material present in the primer layer.

The exposed metal areas present below the primer layer and the resist layer may be demetalized by various methods known to those in the art. However, Applicant has found that whether the metallic layer is applied in a discontinuously or continuously, it is preferable that the metallic layer is demetalized by at least one of chemical etching, mechanical etching, or etching by laser. As used in this context, the term “etching” refers to the selective full (Le., removal of full metal depth down to the base substrate) or partial removal of areas of the metallic layer. In a preferred embodiment, the chemical etching of the metallic layer comprises exposing a metallized and printed substrate to a caustic wash. The caustic wash fully or partially removes the exposed metallic areas to provide de-met areas abutting the masked metal areas. As described herein, the masked metal areas are layered areas comprising at least areas of the base substrate, areas of the metallic layer, areas of the primer layer and areas of the resist layer. By contrast, as described herein, de-met areas are either areas with only base substrate or layered areas comprising areas of the base substrate and areas of the metallic layer that have been partially etched. The contrast between the de-met areas and the masked metal areas provide the micro-text effect whereby negative or positive indicia are provided in the layered system.

In one embodiment, the de-met areas of the layered system comprises between about 10% to about 50% of the area of the layered system or any resulting security device. Correspondingly, the masked metal areas shall comprise between about 90% to about 50% of the area of the layered system or any resulting security device. Dernetallization produces a demetalized metallic and printed substrate.

In one embodiment of the method, the method comprises, inter alio, applying a liquid crystal material to cover the masked metal areas and the de-met areas. Simultaneously, the liquid crystal material also covers the primer layer. Optionally, an adhesive layer may be disposed between the liquid crystal material and the resist layer. Various methods of applying the liquid crystal material will be apparent to the PHOSITA. Nonetheless, Applicant has found that the preferred methods include by laminating, transferring, or coating the liquid crystal material over the resist layer or over the demetalized metallic and printed substrate. The present invention contemplates embodiments such that covering the resist layer with the liquid crystal material includes embodiments where a further layer is disposed between the resist layer and the liquid crystal material. However, in a preferred embodiment, the liquid crystal material is disposed in direct contact with the resist layer.

The layered system results from the application of a liquid crystal material to the demetalized metallic and printed substrate.

In another aspect, the invention provides a layered system. In one embodiment, the layered system comprises a base substrate having a metallic layer with masked metal areas and de-met areas that are disposed on a first side of the base substrate; a patterned primer layer disposed over the metallic layer; a patterned opaque layer disposed over the primer layer such that at least a part of the metallic layer is masked by the opaque layer; and a layer of liquid crystal material disposed over the patterned opaque layer to cover the masked areas and the exposed areas; wherein the metallic layer has masked areas and de-met areas.

As noted herein, the primer layer and the metallic layer may have the same or a different pattern from the opaque layer. The opaque layer is never in contact with the metallic layer. The pattern of the opaque layer provides masked metal areas that may include dark areas or both dark and window areas.

Where the liquid crystal material is disposed over the masked metal areas it will produce a color-shifting effect in reflected light such that an observant will perceive one color scheme from a first point of view but will perceive a different reflective color scheme from a different point of view. The liquid crystal material will be transparent, in reflected light, over the de-met areas. From the opposite side of the liquid crystal material, the an observant will perceive a second color scheme in the de-met area in reflected light and will observe a different transmitted color scheme from the second color scheme in transmitted light.

In one embodiment, the liquid crystal material is in the form of a layer comprising darkly-colored liquid crystal (LC) areas and clear liquid crystal (LC) areas distributed across the layer. In a more specific exemplary embodiment, the darkly-colored LC areas are distributed in a pattern over at least some of the masked metal areas whereas clear (transparent or translucent) LC areas are distributed over at least some of the de-met areas. Alternatively, in one embodiment, the liquid crystal material is in the form of a layer having darkly-colored areas that overlap the masked metal areas and the de-met areas. In one embodiment, the pattern of darkly colored LC areas matches the pattern of masked metal areas. It is also contemplated that the clear liquid crystal areas overlap the de-met areas and the masked metal areas.

Suitable liquid crystal materials include monomeric, polymeric or a combination of monomeric or polymeric or combinations of different monomeric liquid crystal materials. However, in one embodiment, the liquid crystal material that is applied to the demetalized metallic and printed substrate, by covering the resist layer is a monomeric liquid crystal material, In one embodiment, the monomeric liquid crystal material is provided in a device or layered system which includes the primer layer. In an alternate embodiment, where there is no primer layer, the liquid crystal material is provided in its monomeric form and is then cured in situ to a polymeric form.

Accordingly, in another aspect of the invention a monomeric liquid crystal layered system an intermediate layered system) is provided. In one embodiment, the intermediate layered system comprises a base substrate having a metallic layer with masked metal areas and de-met areas that are disposed on a first side of the base substrate; optionally, a patterned primer layer disposed over the metallic layer; a patterned opaque layer disposed over the optional primer layer such that at least a part of the metallic layer is masked by the opaque layer; and a layer of monomeric liquid crystal material disposed over the patterned opaque layer to cover the masked metal areas and the exposed areas; wherein the metallic layer has masked areas and de-met areas,

The monomeric liquid crystal material in the intermediate layered system is cured in situ on the demetalized metallic and printed substrate to produce a layered system which includes a polymeric liquid crystal material. Suitable monomeric liquid crystal materials include, without limitation, those that can either be uv cured or thermally cured in situ. For example, those that can be combined with a photoinitiator and then cured by exposure to uv light. Alternatively, the monomeric liquid crystal material may be those that can be combined with a thereto-initiator then decomposed in the presence of heat. In specific embodiments, suitable monomeric liquid crystal materials include, for example, monomeric biphenyl or terphenyl liquid crystal materials. Applicant has found that by applying the monomeric liquid crystal material, rather than the polymeric form of the liquid crystal material, there was increased in process control relative to the conventional processes that applied a polymeric liquid crystal material. For example, by applying monomeric liquid crystal material over the opaque layer, it is possible to adjust the color-shift effect real-time during a single step manufacturing. That is to say that compared to a polymeric liquid crystal material where the color-shift effect is set prior to application of the liquid crystal material to the laminate of base substrate, metal and resist—using a monomeric liquid crystal material and curing in situ allows real-time adjustment of the color-shift effect in a single phase process. This also improves the process costs since the process is a single phase process as opposed to multiple phases.

As such, in another embodiment, the method comprises providing a base substrate having a metallic layer disposed on a first side of the base substrate; masking at least a part of the metallic layer with an opaque layer to form masked metal areas and exposed metal areas; demetallizing the exposed metal areas to form de-met areas in the metallic layer; and applying a monomeric liquid crystal material to cover the masked metal areas and the de-met areas thereby providing the layered system described throughout herein.

The liquid crystal material produces a color-shift effect depending on the point of view (POV) of the observant. This POV-dependent color-shift in reflected light and the color difference observed in transmitted versus reflected light is due, at least in part, to the chiral nematic phase of the liquid crystal material. For example, liquid crystal material reflects circularly polarized light over a narrow band of wavelengths. The particular band of wavelengths depends on the pitch of the helical structure and the angle of incidence. Accordingly, depending on the choice of the liquid crystal material's chemical composition, only light over a desired range of wavelength will be reflected. This range of wavelengths being further dependent on angle of incidence can be varied by the changing points of view of the observant. The reflection wavelength can therefore be customized by choosing a preferred liquid crystal chemical composition.

This effect is pronounced when the liquid crystal material is disposed against or over a darkly-colored background such as the opaque layer. Here the reflective color-shift effect will be evident to an observant as she changes points of view. A certain portion of the incident light will be reflected while a certain, yet complementary, portion will be transmitted through the liquid crystal material. For example, if the reflected light is green then the transmitted light will be magenta. The liquid crystal material can also be chosen to be temperature sensitive or insensitive.

The layered system produces at least one of a transmitted color-shift and a reflected color-shift. In one embodiment, the layered system provides a transmitted color-shift. Here the layered system, comprising the elements of the respective embodiments described herein, which include a de-met area, which is a layered area of base substrate, optional adhesive layer covering the de-met area and the masked metal area, and the liquid crystal material. While the liquid crystal material layer may be uniformly clear or have a uniform degree of opacity, it is also contemplated that there are clear LC areas and there are opaque/dark LC areas in the liquid crystal material layer. Where the opaque layer includes clear windows, the clear or dark LC areas may overlap those clear windows, though it is preferred that the clear LC areas overlap the clear windows of the opaque layer. Preferably, where the liquid crystal material layer has clear LC areas and opaque LC areas, some clear LC areas are disposed to cover some de-met areas and some opaque/dark LC areas are disposed to cover some masked metal areas. More preferably, the clear LC areas cover only the de-met areas and the opaque/dark LC areas cover only the masked metal areas. In transmitted light, a transmitted color-shift effect will be evident over the de-met area, where the liquid crystal material is clear. Applicant has found that substantial transmitted color-shift effect will be observable under such circumstances, such that the color observed in reflected light is substantially distinct from the color observed in transmitted light; changing from green to the complementary magenta color, for example.

Suitable monomeric liquid crystal materials have an elongated or rod-like structure with a rigid core. Such molecules usually have a permanent electrical dipole and easily polarizable chemical or reactive groups. Preferably, they are readily cross-linkable; especially in exposure to uv light or heat. Low viscosity oligomeric liquid crystal materials are contemplated as well and as used herein shall fall under the category of monomeric liquid crystal material. Specific examples of suitable monomeric liquid crystal materials include, without limitation, monomeric biphenyl or terphenyl liquid crystal materials or mixtures thereof. The monomeric liquid crystal material may be infused with a chiral additive.

In addition to the reflected color-shift and the transmitted color-shift effect provided by the layered system, a micro-text effect is also provided. Here, the micro-text effect is most pronounced where the contrast between the de-met areas and the masked metal areas are most significant. Applicant has surprisingly found that by incorporating a primer layer between the resist layer and the metallic layer, the contrast can be substantially improved even where the primer layer is clear and adds no further opacity to the masked metal area. The transmitted light that is allowed to pass through the de-met areas allows the observant to see the clear contrast between the de-met area and the masked metal area. The de-met area providing negative or positive indicia thereby provides micro-sized indicia in the form of letters, numbers, symbols or any combination thereof. The micro-text effect is observable from the top side (proximate the liquid crystal material) or from the bottom side (proximate the base substrate) of the layered system of security device. From the bottom side, the parts of the metallic layer remaining in the masked metal area provides the contrast against the de-met areas such that the observant can readily and easily observe the micro-text effect. The micro-text has high resolution at least in part due to the sharp edges obtained during the etching of the exposed metallic areas of the metallic layer. This high-resolution etching is enabled in part due to the presence of the primer layer between the opaque layer and the metallic layer.

In another aspect, the invention provides a method of producing a layered system. In one embodiment, the method comprises providing a base substrate having a metallic layer disposed on a first side of the base substrate; applying a nancy layer, as the opaque layer, over at least a part of the metallic layer to form masked metal areas (covered by the nancy layer) and exposed metal areas (not covered by the nancy layer); curing the nancy layer to produce a darkly-colored resist; demetallizing the exposed metal areas to form de-met areas in the metallic layer; applying a liquid crystal material to cover the masked metal areas and the de-met areas. The liquid crystal material provides a color-shift effect and the contrast between the de-met areas and the masked areas operate to provide a micro-text effect,

Suitable materials for use in forming the nancy layer include, for example, clear resists that can be cured in situ or dyed through the addition of pigment in situ to form a darkly-colored resist. A PHOSITA will be able to identify suitable resist materials that can be applied as part of the layered system and then cured or dyed in situ.

In further embodiments, the nancy layer is applied along with at least one primer layer and/or the monomeric liquid crystal material over the base substrate layer with the metallic layer, as described in the various embodiments herein, to form an intermediate layered system with a nancy layer. This intermediate layered system, has a pattern in the nancy layer, the optional primer layer such that this intermediate layered system has masked metal areas and exposed metal areas, allowing for the in situ demetallization of the metallic layer.

In one embodiment, the method further comprises the step of covering the resist layer with a machine readable material layer. For example, the machine readable layer may be a layer of magnetic material disposed over the resist layer or a magnetic material incorporated into the resist layer. Suitable magnetic materials are those that can be used to provide a machine readable code such as those described in WO 1998023236 and include for example magnetite. Where the magnetic material is disposed as a layer above or below the resist layer, this layer may be continuous or discontinuous (i.e., a pattern similar or different from the pattern of the de-met areas in the metallic layer.

In other embodiments, separate materials may be disposed as layers above or below the resist layer or may be incorporated resist layer. For example, it is contemplated herein that IR readable materials may be so incorporated to provide an IR readable code. Fluorescent, phosphorescent or luminescent materials or conductive materials may be provided in the resist layer or above or below the resist layer. In one embodiment, these separate materials are disposed in the masked metal areas and not in the de-met areas.

Layered systems produced by the methods described herein are suitable for use in mitigating counterfeiting attempts. For example, in one embodiment a layered system comprising the various elements of each embodiment described herein is formed into security devices such as patches, foils, strips, stripes, or threads, for example. Various methods of forming such exemplary security devices from the layered system will be apparent to a PHOSITA. Such methods can produce security devices of various shapes, sizes and colors.

In one embodiment, a security document is provided wherein the security device is affixed to the document substrate or embedded or partially embedded within the document's substrate. In a preferred embodiment, the security document is a banknote, check, stamp, passport, identification card or the like. In another embodiment a consumer product is provided wherein the security device is affixed to the product. In a preferred embodiment the consumer product is a high value personal apparel such as clothing, books, computers, or the like. Alternatively, the consumer product is a high security product such as weapons, weapons systems, government systems, machines and products.

Banknotes incorporating the security device may be formed in various ways such as on conventional paper machines such as a Fourdrenier paper making machine. Here the security device may, for example, be in the form of a strip that is embedded into the paper during manufacture by inserting the strip of security device into the paper slurry of cellulosic fibers.

In one embodiment of the claimed invention, the layered system and security device comprises a de-met area, a masked metal area disposed next to the de-met area, and a liquid crystal material disposed over the masked metal area and the de-met area; the masked metal area having a base substrate layer, a demetalized metallic layer, an optional primer layer and an opaque layer while the de-met area comprises the base substrate layer, the liquid crystal material and a fully or partially demetalized area. More specifically, the layered system or the security device comprises least one of (1) a monomeric liquid crystal material, (b) a clear resist layer cured or dyed in situ to provide a darkly-colored resist layer as the opaque layer, and (3) a primer layer disposed between a metallic layer.

### EXAMPLES

The following examples are provided as non-limiting embodiments for the purpose of providing further clarity to the PHOSITA as to certain very specific embodiments of the claimed invention.

### Example 1

### Method of Producing a Layered System

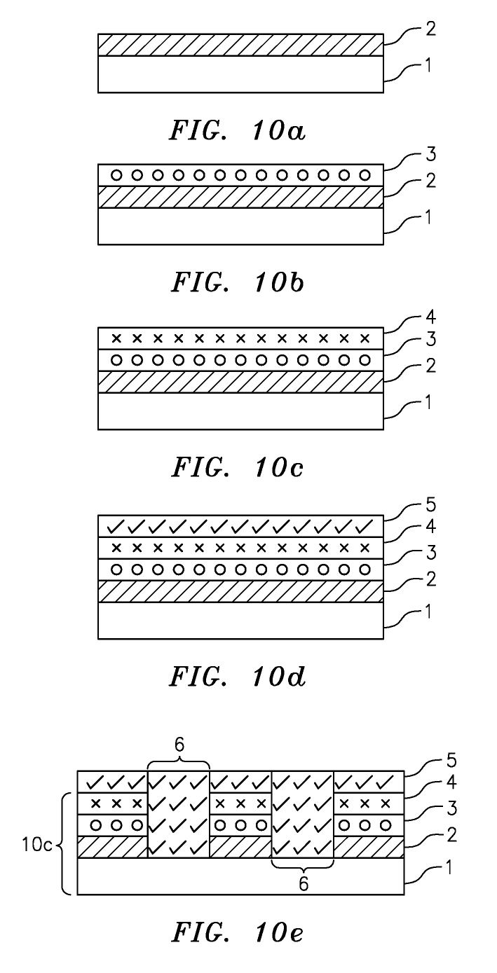

FIGS. 10a-10c provide one example of an embodiment of the claimed invention showing how masked metal areas of a layered system or intermediate layered system are formed. In a first step, shown in FIG. 10a, provides a base substrate 1 with a layer of metal 2 disposed over the base substrate is provided. In a subsequent step, depicted in FIG. 10b, a primer layer 3 is applied over this base substrate 1 with metallic layer 2. In a further step, depicted in FIG. 10c, an opaque layer 4 is applied over the primer layer 3 and the metallic layer 2 to produce a masked metal area and exposed metal areas (not shown) The opaque layer, the primer layer and the metallic layer are as described herein in the various embodiments. In this embodiment, the primer layer and the opaque layer have the same pattern such that the opaque layer is never in contact with the metallic layer. In a subsequent step, the exposed metallic areas are demetalized by any of the methods described herein to produce de-met areas. The masked metal areas 10c and the de-met areas (not shown) are subsequently covered by a liquid crystal material 5 as shown in FIG. 10d to form a layered system.

### Example 2

### A Layered System

FIG. 10e provides an embodiment of the claimed invention. In this embodiment, the layered system comprises a base substrate 1 having a metallic layer 2, with masked metal areas 10c and de-met areas 6. The layered system further comprises patterned primer layer 3 disposed over the metallic layer 2; a patterned opaque layer 4 disposed over the primer layer 3 such that at least a part of the metallic layer 2 is masked by the opaque layer 4; and a layer of liquid crystal material 5 disposed over the patterned opaque layer 4 to cover the masked areas and the de-met areas 6.

### Example 3

### A Layered System

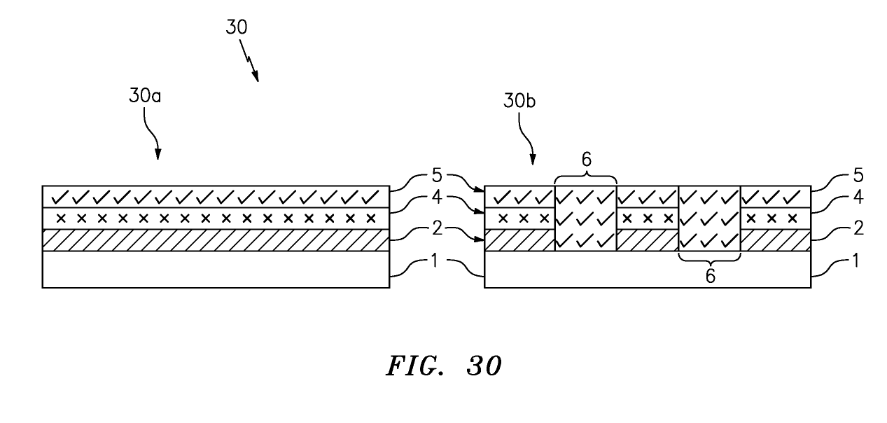

FIG. 30 provides an embodiment of the layered system 30 where the masked metal areas 30a are provided with a base substrate layer 1, a metallic layer 2, an opaque layer 4 and a liquid crystal material 5; and without a primer layer. The opaque layer 4 is provided by applying a clear layer (not shown) over the metallic layer. The clear layer is cured or dyed in, situ to provide a darkly-colored resist layer 4. The darkly-colored resist 4 and the de-met areas 6 are covered by a liquid crystal material 5,

### Example 4

### Consumer Product/Banknote

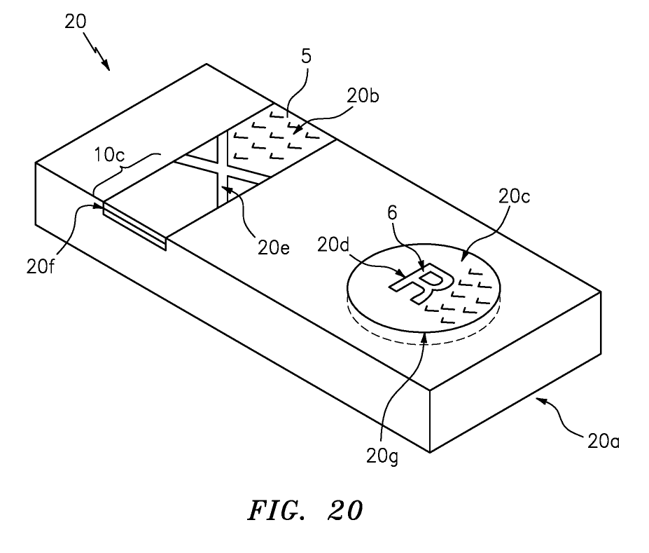

FIG. 20 provides an embodiment of a consumer product 20 such as a banknote 20a comprising a security device 20b (stripe), 20c (patch), having indicia 20d, 20e, that is provided by the contrast between the masked metal area 10c and the de-met areas 6 of the layered system 20f, which provides a micro-text effect. A color-shift effect (not shown) is also provided by the liquid crystal material 5 disposed over the opaque layer (not shown) as part of the masked metal areas 10c.

While various embodiments of the present invention have been described above it should be understood that they have been presented by way of example only, and not limitation. Thus, the breadth and scope of the present invention should not be limited by any of the exemplary embodiments.

The invention claimed is:

1. A method of producing a layered system comprising
providing a base substrate having a metallic layer disposed on a first side of the base substrate;
covering at least a part of the metallic layer with a primer layer;
covering at least a part of the primer layer and masking at least a part of the metallic layer with an opaque layer to form masked metal areas and exposed metal areas;
demetallizing the exposed metal areas to form de-met areas in the metallic layer;
applying a liquid crystal material to cover the masked metal areas and the de-met areas;
wherein the liquid crystal material provides a colorshift effect and the de-met areas and the masked areas operate to provide a micro-text effect.

2. The method of claim 1, wherein the liquid crystal material is a monomeric liquid crystal material.

3. The method of claim 2, further comprising the step of curing the monomeric liquid crystal material to form a polymeric liquid crystal material.

4. The method of claim 1, wherein the demetallizing step comprises partial demetallization of the exposed metal areas.

5. The method of claim 1, wherein the primer layer is in contact with the metallic layer and the opaque layer is a resist layer in contact with the primer layer,

6. The method of claim 1, wherein the primer layer and the opaque layer have an identical pattern such that they each cover the metallic layer in the same areas.

7. The method of claim 1, wherein the primer layer covers the entire metallic layer and the opaque layer has a pattern that covers only parts of the metallic layer; and wherein the method further comprises removal of the primer layer.

8. The method of claim 1, wherein the demetallization step results in at least one of negative or positive indicia in the metallic layer.

9. The method of claim 1, wherein the step of applying the liquid crystal material is by at least one of a coating process, a transfer process, or a lamination process.

10. The method of claim 1, wherein the opaque layer or the primer layer contains at least one machine readable material selected from the group comprising a conductive material or a magnetic material.

11. The method of claim 1, wherein at least one of a fluorescent, luminescent or phosphorescent material is incorporated into at least one of the opaque layer or the primer layer.

12. The method of claim 1, wherein the primer layer is disposed between the opaque layer and the metallic layer such that the opaque layer is disposed at a distance of 0.1 to 5 microns from the metallic layer.

13. A layered system comprising
a base substrate having a metallic layer with masked areas and de-met areas that is disposed on a first side of the base substrate;
a patterned primer layer disposed over the metallic layer;
a patterned opaque layer disposed over the primer layer such that at least a part of the metallic layer is masked by the opaque layer; and
a layer of liquid crystal material disposed over the patterned opaque layer to cover the masked areas and the exposed areas;
wherein the metallic layer has masked areas and de-met areas.

14. The layered system of claim 13, wherein the opaque layer is a resist material.

15. The layered system of claim 13, wherein the liquid crystal material is monomeric, polymeric or a combination thereof.

16. The layered system of claim 13, wherein the patterned primer layer is disposed between the metallic layer and the patterned opaque layer such that the patterned opaque layer is disposed at a distance of 0.1 to 5 microns from the metallic layer.

17. A security device comprising the layered system of claim 13.

18. The security device of claim 17, wherein the security device is provided in the form of a foil, stripe, strip, patch, or thread.

19. A security document comprising the layered system of claim 13.

20. A consumer product comprising the layered system of claim 13.

21. A banknote comprising the layered system of claim 13.

22. A layered system produced by the method of claim 1.

23. The method of claim 1, wherein the primer layer is nitrocellulose.

24. The method of claim 13, wherein the primer layer provides improves micro-text resolution.

25. The method of claim 15, wherein the monomeric liquid crystal material comprises cross-linkable reactive groups.
